(19) United States
(12) Patent Application Publication
(10) Pub. No.: US 2020/0338708 A1
(43) Pub. Date: Oct. 29, 2020

(54) LIFTING GEAR AND PNEUMATIC NAIL GUN HAVING THE SAME

(71) Applicant: BASSO INDUSTRY CORP., Taichung (TW)

(72) Inventor: Chien-Kuo PO, Taichung (TW)

(73) Assignee: BASSO INDUSTRY CORP., Taichung (TW)

(21) Appl. No.: 16/855,548

(22) Filed: Apr. 22, 2020

(30) Foreign Application Priority Data
Apr. 25, 2019 (TW) 108114525

(51) Int. Cl. B25C 1/00; B25C 1/04; B25C 1/06

(52) U.S. Cl. CPC B25C 1/001; B25C 1/06; B25C 1/047

(57) ABSTRACT

A lifting gear is adapted to engage a nail-striking device of a pneumatic nail gun, and includes a gear body, a plurality of fixed teeth and a moving tooth. The gear body is rotatable by electric power, and has an annular peripheral surface formed with a slot. The fixed teeth extend outwardly from the annular peripheral surface of the gear body, and are angularly spaced apart from each other to engage a plurality of spaced-apart engaging teeth of the nail-striking device. The moving tooth is movably mounted in the slot, and is movable relative to the gear body from a default position to a retracted position to facilitate engagement between the fixed teeth and the engaging teeth of the nail-striking device.

### CROSS-REFERENCE TO RELATED APPLICATION

This application claims priority of Taiwanese Patent Application No. 108114525, filed on Apr. 25, 2019.

### FIELD

The disclosure relates to a pneumatic nail gun, and more particularly to a lifting gear and a pneumatic nail gun having the same.

### BACKGROUND

Referring to FIG. 1, a conventional pneumatic nail gun 1 disclosed in U.S. Patent Publication No. 20180154505A1 includes a striking cylinder 11, a nail-striking device 12 that is movably disposed in the striking cylinder 11, and a lifting wheel 13 that is rotatable by electric power.

The nail-striking device 12 has a plurality of engaging teeth 121. The lifting wheel 13 includes a wheel body 131, a plurality of fixed pins 133, a moving pin 134 and a resilient member 135. The wheel body 131 has a wheel surface 132 that extends perpendicular to a rotary axis of the wheel body 131. The fixed pins 133 are connected perpendicularly to the wheel surface 132 of the wheel body 131, and are arranged angularly yet unevenly around the rotary axis of the wheel body 131 in a manner that a portion of the wheel body 131 between two endmost fixed pins 133 is defined as a disengaging section 130. That is, there are no fixed pins 133 disposed in the disengaging section 130. The wheel body 131 further has a slide slot 136 formed in the wheel surface 132 proximate to one of the two endmost fixed pins 133. The moving pin 134 is movably received in the slide slot 136. The resilient member 135 is connected between the wheel surface 131 and the moving pin 135 such that the moving pin 134 is movable relative to the wheel body 131 within the slide slot 136.

When the wheel body 131 of the lifting wheel 13 is driven by electric power to rotate, the fixed pins 133 and the moving pin 134 are moved to engage the engaging teeth 121 of the nail-striking device 12 to thereby move the nail-striking device 12 relative to the striking cylinder 11, and to pressurize air stored in the striking cylinder 11.

When the disengaging section 130 of the wheel body 131 is adjacent to the engaging teeth 121 of the nail-striking device 12, the nail-striking device 12 is not engaged with the lifting wheel 13 so that the pressurized air stored in the striking cylinder 11 is allowed to urge the nail-striking device 12 to strike a nail.

If the moving pin 134 fails to successfully engage the engaging teeth 121 of the nail-striking device 12 due to misalignment of the moving and fixed pins 134, 133 and the engaging teeth 121, the moving pin 134 will be pushed by and move around a corresponding one of the engaging teeth 121, such that the alignment is readjusted and that the following fixed pins 134 are allowed to successfully engage the engaging teeth 121. In such a manner, the lifting wheel 13 is prevented from getting stuck with the nail-striking device 12 due to misalignment.

Since the fixed pins 133 are perpendicular to the wheel surface 132, whether they are formed with the wheel body 131 as one piece or being installed in an assembly, manufacturing of the lifting wheel 13 is more complicated than that of a regular gear or cogwheel.

### SUMMARY

Therefore, the object of the disclosure is to provide a lifting gear and a pneumatic nail gun having the same that is easier to manufacture than is the prior art.

According to an aspect of the disclosure, a lifting gear is adapted for use in a pneumatic nail gun. The pneumatic nail gun includes a machine body, a cylinder, a muzzle device and a nail-striking device. The cylinder has at least a portion disposed in the machine body. The muzzle device is connected to the cylinder and is used for loading a nail. The nail-striking device is movably disposed in the cylinder and the muzzle device and has a plurality of spaced-apart engaging teeth.

The lifting gear includes a gear body, a plurality of fixed teeth and a moving tooth.

The gear body is adapted to be mounted to the muzzle device, is rotatable by electric power, and has an annular peripheral surface formed with a slot.

The fixed teeth extend outwardly from the annular peripheral surface of the gear body, and are angularly spaced apart from each other. The fixed teeth include opposite first and second endmost teeth, and a plurality of intermediate teeth that are disposed between the first and second endmost teeth.

The moving tooth movably engages the slot. A pitch distance between each adjacent pair of the intermediate teeth is equal to a pitch distance between the moving tooth and the first endmost tooth, and is smaller than a pitch distance between the moving tooth and the second endmost tooth.

The lifting gear is rotatable by electric power for engaging the fixed teeth with the engaging teeth of the nail-striking device to thereby move the nail-striking device away from a workpiece-contacting end of the muzzle device.

The lifting gear is further rotatable by electric power for disengaging the fixed teeth from the engaging teeth and moving an untoothed section of the annular peripheral surface between the second endmost tooth and the moving tooth to be adjacent to the engaging teeth, such that the nail-striking device is driven by air pressure in the cylinder to strike the nail.

The moving tooth is movable relative to the gear body from a default position, where rotation of the lifting gear engages the moving tooth with the engaging teeth before engagement between the fixed teeth and the engaging teeth, to a retracted position, where at least a portion of the moving tooth is retracted into the slot so as to facilitate engagement between the first endmost tooth of the fixed teeth and the engaging teeth. According to another aspect of the disclosure, a pneumatic nail gun includes a machine body, a cylinder, a muzzle device, a nail-striking device and the above-mentioned lifting gear.

The cylinder has at least a portion disposed in the machine body. The muzzle device is connected to the cylinder and is adapted for loading a nail. The nail-striking device is movably disposed in the cylinder and the muzzle device, and has a plurality of spaced-apart engaging teeth.

The lifting gear as mentioned is rotatable by electric power for engaging with the engaging teeth of the nail-striking device to thereby move the nail-striking device away from a workpiece-contacting end of the muzzle device, and is further rotatable by electric power for being disengaged from the engaging teeth of the nail-striking device such that the nail-striking device is driven by air pressure in the cylinder to strike the nail.

### BRIEF DESCRIPTION OF THE DRAWINGS

Other features and advantages of the disclosure will become apparent in the following detailed description of the embodiment with reference to the accompanying drawings, of which:

FIG. 1 is a fragmentary sectional view illustrating a conventional pneumatic nail gun that is disclosed in U.S. Patent Application No. 20180154505A1;

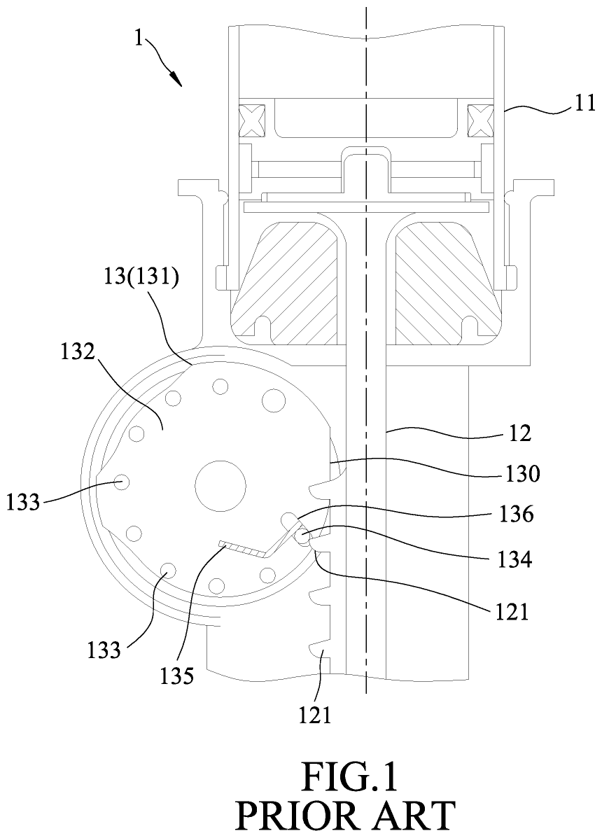

FIG. 2 is a fragmentary sectional view illustrating an embodiment of a pneumatic nail gun according to the disclosure;

FIG. 3 is an exploded perspective view of a lifting gear of the embodiment;

FIG. 4 is a fragmentary perspective view of the embodiment;

FIG. 5 is a view similar to FIG. 2, illustrating a piston of a nail-striking device of the embodiment at a nail-striking position;

FIG. 6 is an enlarged fragmentary sectional of the embodiment, illustrating a moving tooth of the lifting gear of the embodiment at a default position;

FIG. 7 is another fragmentary sectional view of the embodiment, illustrating the moving tooth of the lifting gear of the embodiment at a retracted position; and

FIG. 8 is a view similar to FIG. 7, illustrating a fixed tooth adjacent to the moving tooth being engaged with an engaging tooth.

### DETAILED DESCRIPTION

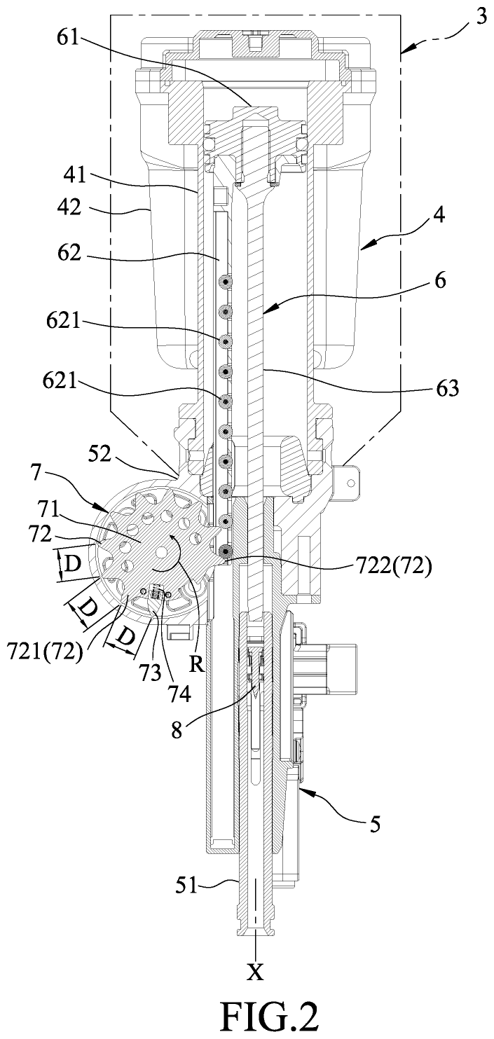

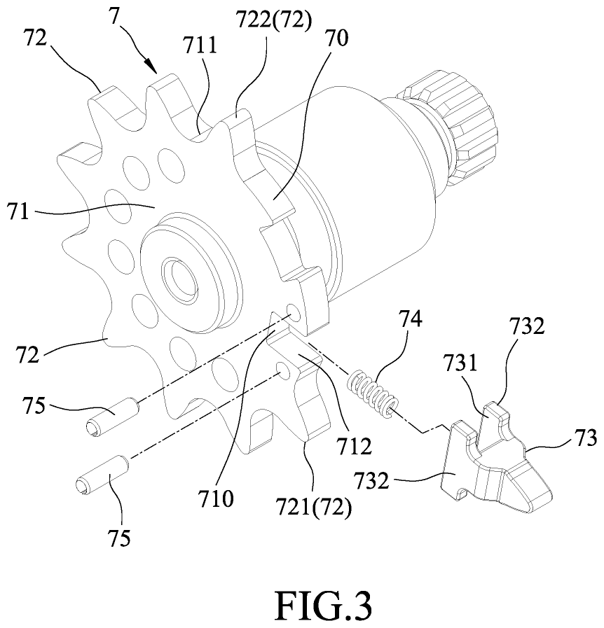

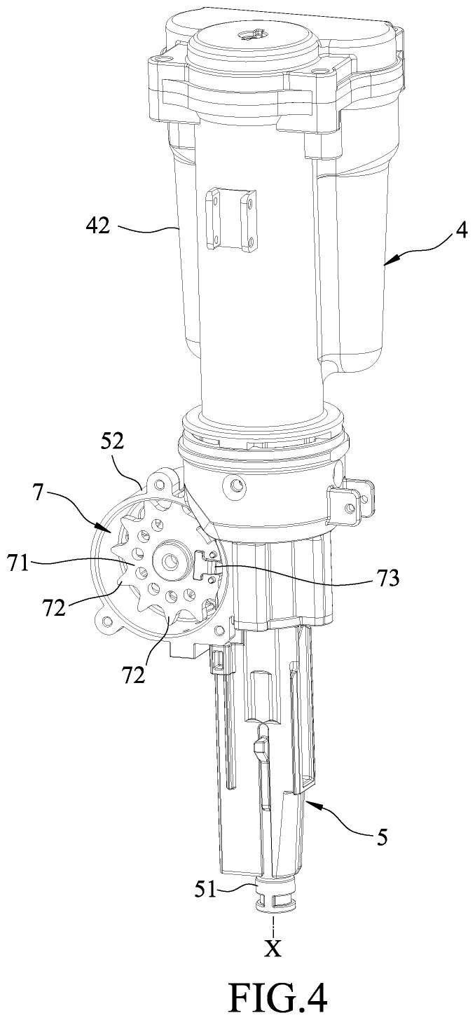

Referring to FIGS. 2 to 4, an embodiment of a pneumatic nail gun according to the disclosure includes a machine body 3, a cylinder unit 4, a muzzle device 5, a nail-striking device 6 and a lifting gear 7.

The cylinder unit 4 includes a cylinder 41 and a storage container 42. The cylinder 41 has at least a portion disposed in the machine body 3, and is adapted for holding air under a predetermined pressure. The storage container 42 is connected to and spatially communicated with the cylinder 41, such that the air in the cylinder 41 is allowed to flow into and be stored in the storage container 42.

The muzzle device 5 includes a muzzle 51 and a base seat 52. The muzzle 51 is connected to the cylinder 41 and is used for loading a nail 8 (see FIG. 2). The base seat 52 is connected between the cylinder 41 and the muzzle 51.

The nail-striking device 6 is movably disposed in the cylinder 41 and the muzzle device 5, and includes a piston 61, a lifting rod 62 and a nail-striking pin 63.

The piston 61 is movably disposed in the cylinder 41, and makes an air-tight contact with an inner surface of the cylinder 41. The lifting rod 62 is detachably connected to the piston 61, and has a plurality of spaced-apart engaging teeth 621. In the present embodiment, the engaging teeth 621 are configured as cylindrical columns. The nail-striking pin 63 is detachably connected to the piston 61, extends parallel to the lifting rod 62, and is movable relative to the muzzle 51 of the muzzle device 5 for striking the nail 8.

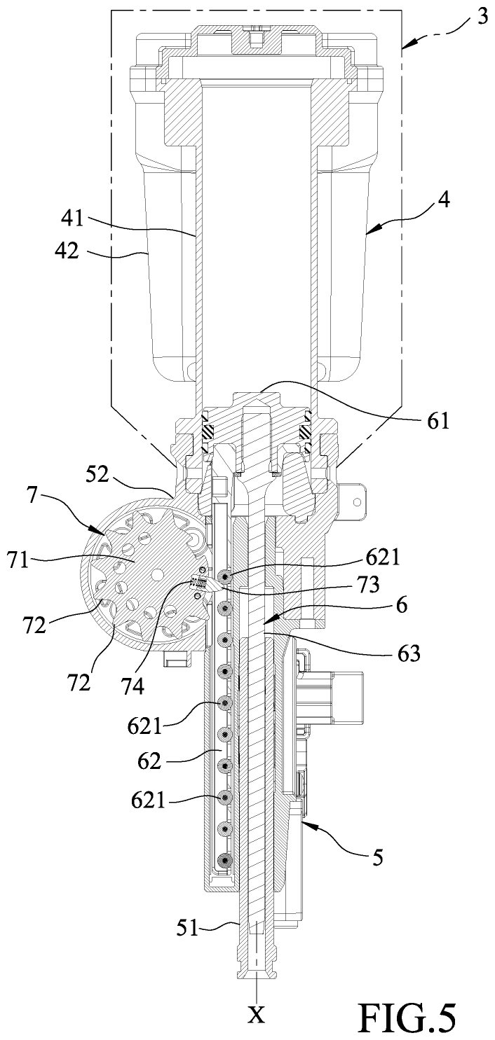

The nail-striking device 6 is movable relative the muzzle device 5 along an axis (X) between a standby position (see FIG. 2), where the nail-striking device 6 is away from a workpiece-contacting end of the muzzle 51 of the muzzle device 5, and a nail-striking position (see FIG. 5), where the nail-striking device 6 is proximate to the workpiece-contacting end of the muzzle 51 of the muzzle device 5 for the nail-striking pin 63 to strike the nail 8.

The lifting gear 7 includes a gear body 71, a plurality of fixed teeth 72, a moving tooth 73, a resilient member 74 and two stop pins 75.

The gear body 71 of the lifting gear 7 is mounted to the base seat 52 of the muzzle device 5, is rotatable by electric power, and has an annular peripheral surface 711 formed with a slot 712. In the present embodiment, the gear body 71 rotates unidirectionally in a rotary direction (R) (see FIGS. 2 and 5).

The fixed teeth 72 extend outwardly from the annular peripheral surface 711 of the gear body 71, and are angularly spaced apart from each other. Specifically, the fixed teeth 72 include opposite first and second endmost teeth 721, 722 and a plurality of intermediate teeth that are disposed between the first and second endmost teeth 721, 722. In the present embodiment, the fixed teeth 72 and the gear body 71 are molded as one piece.

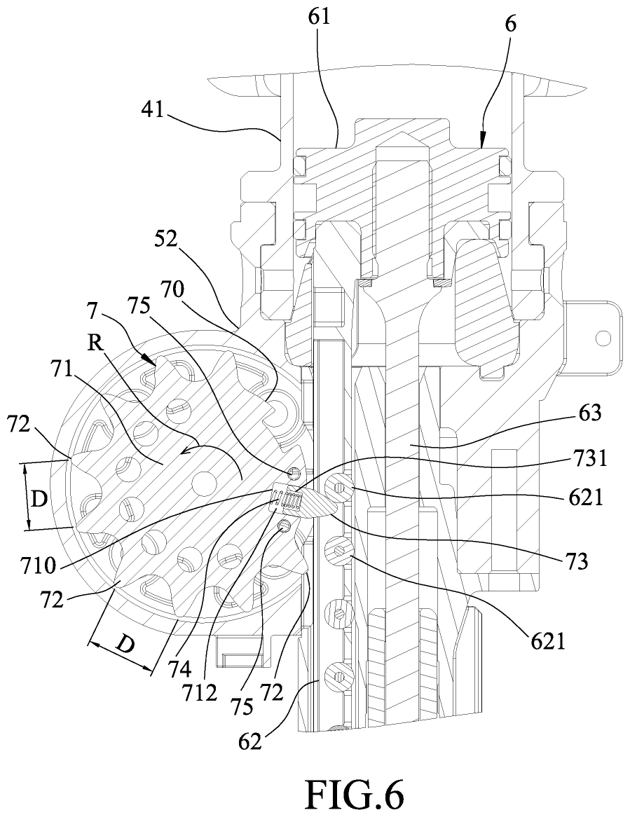

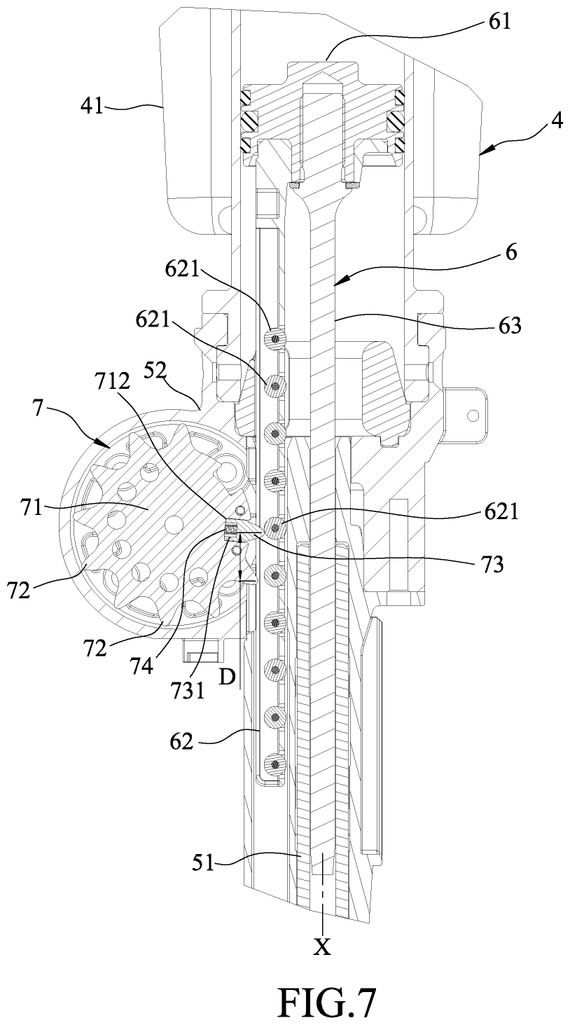

The moving tooth 73 movably engages the slot 712, and is movable relative to the gear body 71 from a default position (see FIG. 6), where the rotation of the lifting gear 7 engages the moving tooth 73 with the engaging teeth 621 of the nail-striking device 6 before engagement between the fixed teeth 72 and the engaging teeth 621, to a retracted position (see FIG. 7), where at least a portion of the moving tooth 73 is retracted into the slot 712 so as to facilitate engagement between the first endmost tooth 721 of the fixed teeth 72 and the engaging teeth 621. The annular peripheral surface 711 has an untoothed section 70 formed between the second endmost tooth 722 and the moving tooth 73.

It should be noted that, a pitch distance (D) between each adjacent pair of the intermediate teeth is equal to a pitch distance between the moving tooth 73 and the first endmost tooth 721 and is smaller than a pitch distance between the moving tooth 73 and the second endmost tooth 722.

Specifically on configurations of the lifting gear 7, the slot 712 of the gear body 71 is defined by a slot-defining surface 710. The moving tooth 73 has a receiving space 731 that faces the slot-defining surface 710, and two tab portions 732.

The resilient member 74 is disposed in the slot 712 of the gear body 71 and has an end portion that abuts against the slot-defining surface 710, and an opposite end portion that is received in the receiving space 731 of the moving tooth 73 for biasing the moving tooth 73 toward the default position.

The tab portions 732 of the moving tooth 73 flank the gear body 71 and the resilient member 74. The stop pins 75 extend transversely through the gear body 71, and abut against the tab portions 732 of the moving tooth 73 when the moving tooth 73 is at the default position for preventing the moving tooth 73 from falling out of the slot 712 of the gear body 71.

Referring to FIGS. 2 and 5, during operation, the gear body 71 of the lifting gear 7 is rotated by electric power in the rotary direction (R) to engage the moving and fixed teeth 73, 72 with the engaging teeth 621 of the nail-striking device 6, thereby moving the nail-striking device 6 away from the workpiece-contacting end of the muzzle 51 of the muzzle device 5 toward the standby position. During this process, the air stored in the cylinder 41 of the cylinder unit 4 is pressurized by the piston 61 of the nail-striking device 6 and is urged to flow into the storage container 42.

It should be noted that, in the present embodiment, a one way bearing (not shown) is mounted to the lifting gear 7, that is, the lifting gear 7 is not allowed to rotate in the direction opposite to the rotary direction (R). Thus, as long as the engaging teeth 621 of the nail-striking device 6 are engaged with the lifting gear 7, the nail-striking device 6 is not permitted to move toward the nail-striking position.

As the lifting gear 7 keeps rotating and drives the nail-striking device 6 to the standby position, the second endmost tooth 722 is disengaged from the engaging teeth 621, and the untoothed section 70 of the annular peripheral surface 711 is moved to be adjacent to the engaging teeth 621. At this moment, movement of the nail-striking device 6 is no longer restricted by the lifting gear 7 and thus, air pressure in the cylinder 41 of the cylinder unit 4 is allowed to push the piston 61 along the axis (X) toward the workpiece-contacting end of the muzzle 51 of the muzzle device 5. Consequently, the nail-striking device 6 is driven toward the nail-striking position, causing the nail-striking pin 63 to strike the nail 8.

At this point, if the lifting gear 7 is further rotated by electric power, the above-mentioned process will be repeated to perform another nail-striking process.

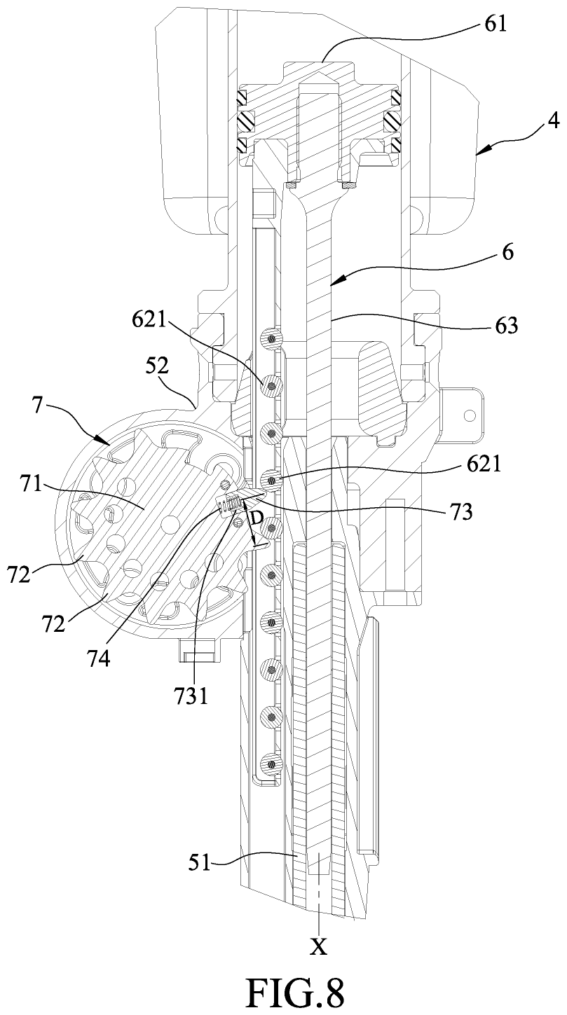

Referring to FIGS. 7 and 8, when the nail-striking pin 63 fails to reach the nail-striking position before the nail-striking process begins due to occurrence of an abnormal condition (such as small objects entering the muzzle 51 and interfering with the movement of the nail-striking pin 63), the engaging teeth 621 of the lifting rod 62 become misaligned with the moving and fixed teeth 73, 72. In such a condition, as the moving tooth 73 makes contact with a corresponding one of the engaging teeth 621 during the rotation of the lifting gear 7, the moving tooth 73 will be forced by the corresponding one of the engaging teeth 621 to move from the default position toward the retracted position against the resilient force of the resilient member 74, such that the moving tooth 73, driven by the rotation of the gear body 71, will glide across an outer surface of the corresponding one of the engaging teeth 621. During this time, the pitch distance (D) between the moving tooth 73 and the fixed teeth 72 is changed, which in turn readjusts the alignment between the engaging teeth 621 and the following fixed tooth 72, (i.e., the first endmost tooth 721).

Once the moving tooth 73 is detached from an outer surface of the corresponding one of the engaging teeth 621, it is biased by the resilient member 74 back to the default position, and the first endmost tooth 721, as well as the rest of the fixed teeth 72, is able to successfully engage the engaging teeth 621 to continue the rest of the operation. In virtue of such readjusting process, the moving tooth 73 is prevented from being stuck with the engaging teeth 621 and interrupting the whole operation.

In sum, the pneumatic nail gun according to the disclosure has advantages as follows.

Since the configuration of the lifting gear 7 resembles a regular gear, and since the gear body 71 and the fixed teeth 72 are molded as one piece, from a manufacturing standpoint, the present embodiment is simpler than the prior art, in which configuration of the lifting wheel 13 is different from a regular gear.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment”, an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A lifting gear adapted for use in a pneumatic nail gun, the pneumatic nail gun including a machine body, a cylinder that has at least a portion disposed in the machine body, a muzzle device that is connected to the cylinder and that is used for loading a nail, and a nail-striking device that is movably disposed in the cylinder and the muzzle device and that has a plurality of spaced-apart engaging teeth, said lifting gear comprising:
a gear body that is adapted to be mounted to the muzzle device, that is rotatable by electric power, and that has an annular peripheral surface formed with a slot;
a plurality of fixed teeth that extend outwardly from said annular peripheral surface of said gear body, and that are angularly spaced apart from each other, said fixed teeth including opposite first and second endmost teeth and a plurality of intermediate teeth that are disposed between said first and second endmost teeth (721, 722); and
a moving tooth that movably engages said slot, a pitch distance between each adjacent pair of said intermediate teeth being equal to a pitch distance between said moving tooth and said first endmost tooth and being smaller than a pitch distance between said moving tooth and said second endmost tooth;
wherein said lifting gear is rotatable by electric power for engaging said fixed teeth with the engaging teeth of the nail-striking device to thereby move the nail-striking device away from a workpiece-contacting end of the muzzle device;
wherein said lifting gear is further rotatable by electric power for disengage said fixed teeth from the engaging teeth and moving an untoothed section of said annular peripheral surface between said second endmost tooth and said moving tooth to be adjacent to the engaging teeth, such that the nail-striking device is driven by air pressure in the cylinder to strike the nail; and
wherein said moving tooth is movable relative to said gear body from a default position, where rotation of said lifting gear engages said moving tooth with the engaging teeth before engagement between said fixed teeth and the engaging teeth, to a retracted position, where at least a portion of said moving tooth is retracted into said slot so as to facilitate engagement between said first endmost tooth of said fixed teeth and the engaging teeth.

2. The lifting gear as claimed in claim 1, further comprising a resilient member that is disposed in said slot for biasing said moving tooth toward the default position.

3. The lifting gear as claimed in claim 2, wherein:
said slot is defined by a slot-defining surface;
said moving tooth has a receiving space that faces said slot-defining surface; and
said resilient member has an end portion that abuts against said slot-defining surface, and an opposite end portion that is received in said receiving space.

4. The lifting gear as claimed in claim 3, wherein:
said moving tooth further has two tab portions that flank said gear body and said resilient member; and
said lifting gear further comprises two stop pins that extend transversely through said gear body, and that abut against said tab portions of said moving tooth when said moving tooth is at the default position for preventing said moving tooth from falling out of said slot of said gear body.

5. A pneumatic nail gun comprising:
a machine body;
a cylinder that has at least a portion disposed in said machine body;
a muzzle device that is connected to said cylinder and that is adapted for loading a nail;
a nail-striking device that is movably disposed in said cylinder and said muzzle device, and that has a plurality of spaced-apart engaging teeth; and
said lifting gear as claimed in claim 1 that is rotatable by electric power for engaging with said engaging teeth of said nail-striking device to thereby move the nail-striking device away from a workpiece-contacting end of said muzzle device, and that is further rotatable by electric power for being disengaged from said engaging teeth of said nail-striking device such that the nail-striking device is driven by air pressure in the cylinder to strike the nail.

6. The pneumatic nail gun as claimed in claim 5, wherein said lifting gear further includes a resilient member that is disposed in said slot for biasing said moving tooth toward the default position.

7. The pneumatic nail gun as claimed in claim 6, wherein:
said slot of said gear body of said lifting gear is defined by a slot-defining surface;
said moving tooth has a receiving space that faces said slot-defining surface; and
said resilient member has an end portion that abuts against said slot-defining surface, and an opposite end portion that is received in said receiving space.

8. The pneumatic nail gun as claimed in claim 7, wherein:
said moving tooth further has two tab portions that flank said gear body and said resilient member; and
said lifting gear further comprises two stop pins that extend transversely through said gear body, and that abut against said tab portions of said moving tooth when said moving tooth is at the default position for preventing said moving tooth from falling out of said slot of said gear body.

9. The pneumatic nail gun as claimed in claim 6, wherein said nail-striking device includes:
a piston that is movably disposed in said cylinder, and that makes an air-tight contact with an inner surface of said cylinder;
a lifting rod that is connected to said piston, and that has said engaging teeth; and
a nail-striking pin that is connected to said piston, that extends parallel to said lifting rod, and that is movable relative to said muzzle device for striking the nail.
